(19) United States
(12) Patent Application Publication
(10) Pub. No.: US 2025/0145019 A1
(43) Pub. Date: May 8, 2025

(54) Drift and Power Slide Mode for a Vehicle

(71) Applicant: Karma Automotive LLC, Irvine, CA (US)

(72) Inventors: Fazel Farahmand, Aliso Viejo, CA (US); Bradley Ketchel, Huntington Beach, CA (US)

(73) Assignee: Karma Automotive LLC, Irvine, CA (US)

(21) Appl. No.: 18/933,830

(22) Filed: Oct. 31, 2024

Related U.S. Application Data
(60) Provisional application No. 63/596,670, filed on Nov. 7, 2023.

(51) Int. Cl. B60L 15/20

(52) U.S. Cl. CPC B60L 15/20; B60L 2240/24; B60L 2250/16; B60L 2250/24; B60L 2260/20

(57) ABSTRACT

A method includes receiving a turning angle indication indicating a turn of front wheels of the vehicle in one of a left direction or a right direction by a turning angle relative to a first direction of travel of the vehicle, and determining that a magnitude of the turning angle satisfies a threshold turn angle. Based on determining that the magnitude of the turning angle satisfies the threshold turn angle, the method also includes operating the vehicle in a drift mode by determining that an inner rear wheel includes one of a left rear wheel or a right rear wheel of the vehicle, determining that an outer rear wheel includes the other one of the left rear wheel or the right rear wheel, and commanding at least one torque machine to provide forward torque to the inner rear wheel without providing any forward torque to the outer rear wheel of the vehicle.

### TECHNICAL FIELD

This U.S. patent application claims priority under 35 U.S.C. § 119 (e) to U.S. Provisional Application 63/596,670, filed on Nov. 7, 2023. The disclosure of this prior application is considered part of the disclosure of this application and is hereby incorporated by reference in its entirety.

### TECHNICAL FIELD

This disclosure relates to a drift and power slide mode for a vehicle.

### BACKGROUND

Sporty track race maneuvers are popular among car enthusiasts. These maneuvers are performed manually by a skilled driver. For instance, a power slide maneuver requires the skilled driver to manually balance both the steering wheel and throttle/accelerator pedal input after an apex of a turning maneuver to complete a desired turning maneuver. Similarly, a drift maneuver prior to entering a turn requires the skilled driver to balance the steering wheel and apply hand braking to cause the vehicle to slide sideways before the vehicle enters an apex of the turn.

### SUMMARY

One aspect of the disclosure provides A computer-implemented method executing on data processing hardware of a vehicle that causes the data processing hardware to perform operations, During operation of the vehicle in a normal driving mode, the operations include receiving a turning angle indication indicating a turn of front wheels of the vehicle in one of a left direction or a right direction by a turning angle relative to a first direction of travel of the vehicle, and determining that a magnitude of the turning angle satisfies a threshold turn angle. Based on determining that the magnitude of the turning angle satisfies the threshold turn angle, the operations also include operating the vehicle in a drift mode by determining that an inner rear wheel includes one of a left rear wheel or a right rear wheel of the vehicle, determining that an outer rear wheel includes the other one of the left rear wheel or the right rear wheel, and commanding at least one torque machine to provide forward torque to the inner rear wheel without providing any forward torque to the outer rear wheel of the vehicle.

Implementations of the disclosure may include one or more of the following optional features. In some implementations, during operation of the vehicle in the normal driving mode, the at least one torque machine is providing forward torque to each of the right rear wheel and the left rear wheel of the vehicle to propel the vehicle along a surface in the first direction of travel substantially parallel to a longitudinal axis of the vehicle. In some additional implementations, determining that the inner rear wheel includes one of the left rear wheel or the right rear wheel includes: determining that the inner rear wheel includes the left rear wheel when the turning angle indication indicates the turn of the front wheels in the left direction; or determining that the inner rear wheel includes the right rear wheel when the turning angle indication indicates the turn of the front wheels in the right direction.

In some examples, during operation of the vehicle in the drift mode, commanding the at least one torque machine to provide forward toque to the inner rear wheel without providing any forward torque to the outer rear wheel of the vehicle includes commanding the at least one torque machine to not provide any torque to the outer rear wheel to permit the outer rear wheel to rotate freely. In other examples, during operation of the vehicle in the drift mode, commanding the at least one torque machine to provide forward torque to the inner rear wheel without providing any forward torque to the outer rear wheel of the vehicle includes commanding the at least one torque machine to provide a backward torque to the outer rear wheel of the vehicle.

In some implementations, the operations also include receiving a drift mode enable request from a passenger of the vehicle to enable operation of the vehicle in the drift mode and transitioning the vehicle from operating in the normal driving mode to the drift mode in response to determining that both operation of the vehicle in the drift mode is enabled and the magnitude of the turning angle satisfies the threshold turn angle. Here, the passenger may issue the drift mode enable request via at least one of: pressing a physical button disposed in an interior of the vehicle; actuating a lever or switch disposed in an interior of the vehicle; selecting a graphical element presented in a graphical user interface displayed on a screen in the interior of the vehicle; selecting a graphical element presented in a graphical user interface displayed on a screen of a mobile computing device associated with the passenger; or receiving a voice command spoken by the passenger that requests to enable the operation of the vehicle in the drift mode.

In some examples, operating the vehicle in the drift mode further includes determining that an inner front wheel comprises one of a left front wheel or a right front wheel, determining that an outer front wheel comprises the other one of the left front wheel or the right front wheel, and commanding the at least one torque machine to provide forward torque to the inner front wheel without providing any forward torque to the outer front wheel of the vehicle. The at least one torque machine may include a first electric motor and a second electric motor. The first electric motor is connected to the right rear wheel and configured to provide forward torque or backward torque to the right rear wheel, while the second electric motor is connected to the left rear wheel and configured to provide forward torque or backward torque to the left rear wheel. The operations may further include receiving a velocity of the vehicle when the turning angle indication indicating the turn of front wheels of the vehicle in one of the left direction or the right direction is received. Here, operating the vehicle in the drift mode further includes determining a value of the turn angle threshold based on the velocity of the vehicle.

In some implementations, receiving the turning angle indication includes receiving a steering wheel input indicating rotation of the steering wheel in one of a counterclockwise direction to cause the front wheels to turn in the left direction or the clockwise direction to cause the front wheels to turn in the right direction. In these implementations, the magnitude of the turning angle is proportional to an amount the steering wheel rotates in the one of the counterclockwise direction or the clockwise direction. In these implementations, the operations also include determining that the steering wheel input indicates rotation of the steering wheel in the one of the counterclockwise direction or the clockwise direction by a threshold amount within a threshold period of time. Here, operating the vehicle in the drift mode is further based on determining that the steering wheel input indicates the rotation of the steering wheel in the one of the counterclockwise direction or the clockwise direction by the threshold amount within the threshold period of time.

Another aspect of the disclosure provides a vehicle that includes a pair of front wheels, a pair of rear wheels, at least one torque machine, and a controller in communication with the at least one torque machine and configured to perform operations that include, during operation of the vehicle in a normal driving mode, receiving a turning angle indication indicating a turn of front wheels of the vehicle in one of a left direction or a right direction by a turning angle relative to a first direction of travel of the vehicle, and determining that a magnitude of the turning angle satisfies a threshold turn angle. Based on determining that the magnitude of the turning angle satisfies the threshold turn angle, the operations also include operating the vehicle in a drift mode by determining that an inner rear wheel includes one of a left rear wheel or a right rear wheel of the vehicle, determining that an outer rear wheel includes the other one of the left rear wheel or the right rear wheel, and commanding at least one torque machine to provide forward torque to the inner rear wheel without providing any forward torque to the outer rear wheel of the vehicle

In some examples, during operation of the vehicle in the drift mode, commanding the at least one torque machine to provide forward toque to the inner rear wheel without providing any forward torque to the outer rear wheel of the vehicle includes commanding the at least one torque machine to not provide any torque to the outer rear wheel to permit the outer rear wheel to rotate freely. In other examples, during operation of the vehicle in the drift mode, commanding the at least one torque machine to provide forward torque to the inner rear wheel without providing any forward torque to the outer rear wheel of the vehicle includes commanding the at least one torque machine to provide a backward torque to the outer rear wheel of the vehicle.

In some implementations, the operations also include receiving a drift mode enable request from a passenger of the vehicle to enable operation of the vehicle in the drift mode and transitioning the vehicle from operating in the normal driving mode to the drift mode in response to determining that both operation of the vehicle in the drift mode is enabled and the magnitude of the turning angle satisfies the threshold turn angle. Here, the passenger may issue the drift mode enable request via at least one of: pressing a physical button disposed in an interior of the vehicle; actuating a lever or switch disposed in an interior of the vehicle; selecting a graphical element presented in a graphical user interface displayed on a screen in the interior of the vehicle; selecting a graphical element presented in a graphical user interface displayed on a screen of a mobile computing device associated with the passenger; or receiving a voice command spoken by the passenger that requests to enable the operation of the vehicle in the drift mode.

In some examples, operating the vehicle in the drift mode further includes determining that an inner front wheel comprises one of a left front wheel or a right front wheel, determining that an outer front wheel comprises the other one of the left front wheel or the right front wheel, and commanding the at least one torque machine to provide forward torque to the inner front wheel without providing any forward torque to the outer front wheel of the vehicle. The at least one torque machine may include a first electric motor and a second electric motor. The first electric motor is connected to the right rear wheel and configured to provide forward torque or backward torque to the right rear wheel, while the second electric motor is connected to the left rear wheel and configured to provide forward torque or backward torque to the left rear wheel. The operations may further include receiving a velocity of the vehicle when the turning angle indication indicating the turn of front wheels of the vehicle in one of the left direction or the right direction is received. Here, operating the vehicle in the drift mode further includes determining a value of the turn angle threshold based on the velocity of the vehicle.

In some implementations, receiving the turning angle indication includes receiving a steering wheel input indicating rotation of the steering wheel in one of a counterclockwise direction to cause the front wheels to turn in the left direction or the clockwise direction to cause the front wheels to turn in the right direction. In these implementations, the magnitude of the turning angle is proportional to an amount the steering wheel rotates in the one of the counterclockwise direction or the clockwise direction. In these implementations, the operations also include determining that the steering wheel input indicates rotation of the steering wheel in the one of the counterclockwise direction or the clockwise direction by a threshold amount within a threshold period of time. Here, operating the vehicle in the drift mode is further based on determining that the steering wheel input indicates the rotation of the steering wheel in the one of the counterclockwise direction or the clockwise direction by the threshold amount within the threshold period of time.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a vehicle

FIG. 2 is a schematic view of the vehicle operating in a normal drive mode.

FIGS. 3A and 3B are schematic views of a vehicle operating in a drift mode.

FIG. 4 is a flowchart of an example arrangement of operations for a method of operating a vehicle in a drift mode.

FIG. 5 is a schematic view of an example computing device that may be used to implement the systems and methods described herein.

Like reference symbols in the various drawings indicate like elements.

### DETAILED DESCRIPTION

Power sliding in a vehicle is the act of increasing forward torque to rear wheels to cause the rear wheels to spin while cornering through a turn such that natural momentum of the vehicle results in a rear/back portion of the vehicle swinging outward in a direction away from a direction of the turn. Since the natural momentum of the vehicle during the turn is required for the power sliding effect, power sliding maneuvers are typically commenced after the wheels of the vehicle turn inward such that the bulk of the sideways power sliding effect occur after an apex of the turn. By contrast, drifting in a vehicle refers to maneuvering the vehicle to slip sideways before initiating the turning maneuver. The drifting maneuver is manually performed by balancing various techniques to initiate and hold the slide that include yanking a handbrake, clutch kicking, modulating accelerator/throttle, and steering into the slide from before the turning maneuver begins to well after its ended.

Implementations herein are directed toward operating a vehicle in a drift and power slide mode that permits a novice driver to initiate and hold a drift and/or power slide without requiring the driver to manually balance throttle/acceleration input, steering wheel position, as well as other techniques such as yanking a handbrake and clutch kicking. Notably, the vehicle need not be equipped with a handbrake or require a manual transmission to operate in the drift and power slide mode. As such, implementations herein are applicable to electric vehicles and hybrid electric vehicles.

As used herein, the drift and power slide mode may permit the vehicle to perform both the drift maneuver, before and during initiation of a turning maneuver, and the power slide maneuver occurring after the apex of the turning maneuver. Similarly, the drift and power slide mode may permit the vehicle to perform the power slide maneuver alone without first performing the drift as part of the turn maneuver. By the same notion, the drift and power slide mode may permit the vehicle to perform the drift maneuver before and during initiation of the turning maneuver without following up to perform the power slide. Whether the vehicle performs both of the drift and power slide maneuvers or only one of the maneuvers may depend on steering wheel inputs by the driver, speed of the vehicle, acceleration of the vehicle, and/or orientation of the vehicle at any time while the drift and power slide mode is enabled during operation of the vehicle.

Implementations herein include, while operating a vehicle in a normal driving mode in which at least one torque machine is providing forward torque to rear wheels of the vehicle to propel the vehicle along a surface in a first direction of travel substantially parallel to a longitudinal axis of the vehicle, receiving a turning angle indication indicating a turn of front wheels of the vehicle in one of a left direction or a right direction by a turning angle relative to the first direction of travel and determining that a magnitude of the turning angle satisfies a threshold turn angle. The vehicle then transitions to operating in a drift and power slide mode based on determining that the magnitude of the turning angle satisfies the threshold turn angle. The vehicle operates in the drift and power slide mode by determining that an inner rear wheel includes one of a left rear wheel or a right rear wheel, determining that an outer rear wheel includes the other one of the left rear wheel or the right rear wheel, and commanding the at least one torque machine to provide forward torque to the inner rear wheel without providing any forward torque to the outer rear wheel of the vehicle. Here, a vehicle controller may command the at least one torque machine to not provide any torque (forward or backward torque) to the outer rear wheel or the vehicle controller may command the at least one torque machine to provide backward torque to the outer rear wheel of the vehicle.

The inner rear wheel includes the left rear wheel when the turning angle indication indicates the turn of the front wheels in the left direction. Here, the outer rear wheel would include the right rear wheel. Conversely, the inner rear wheel includes the right rear wheel when the turning angle indication indicates the turn of the front wheels in the right direction. Here, the outer rear wheel would include the left rear wheel.

In some configurations, the vehicle includes a rear-wheel drive (RWD) vehicle in which the at least one torque machine is only capable of powering the rear wheels of the vehicle independently such that the front wheels of the vehicle are configured to spin freely and never receive torque from the torque machine. In other configurations, the vehicle includes a four-wheel drive (4WD)/all-wheel drive (AWD) vehicle in which the at least one torque machine powers all the wheels of the vehicle independently. In these configurations, during operation of the vehicle in the drift and power slide mode, the vehicle controller may command the at least one torque machine to provide forward torque to each of the inner front wheel and the inner rear wheel without providing any forward torque to the outer front wheel and the outer rear wheel. Here, the vehicle controller may command the at least one torque machine to not provide any torque (forward or backward torque) to the outer front wheel and the outer rear wheel or the vehicle controller may command the at least one torque machine to provide backward torque to both the outer front wheel and the outer rear wheel. The vehicle controller may command the at least one torque machine to provide backward torque to the outer front and rear wheels independently such that the magnitude of torque provided to the outer rear wheel is greater/less than the magnitude of backward torque provided to the outer front wheel. In some scenarios, the vehicle controller may command the at least one torque machine to provide backward torque to only one of the outer front wheel or the outer rear wheel while the other one of the outer front wheel or the outer rear wheel is not provided any torque and permitted to spin freely.

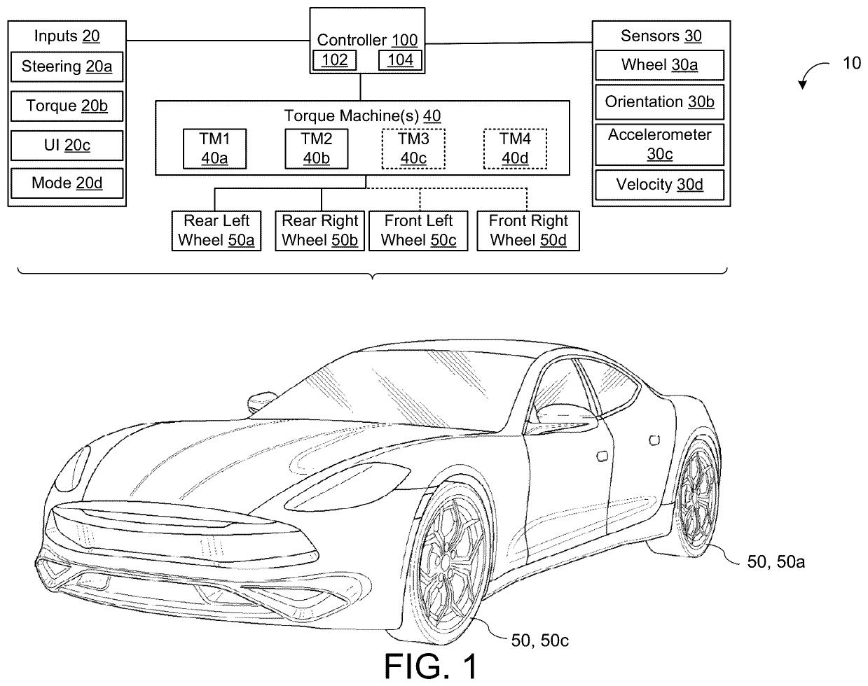

Referring to FIG. 1, in some implementations, a vehicle 10 includes a controller 100, at least one torque machine 40, wheels 50, 50a-d, and multiple vehicle sensors 30. While one controller 100 is depicted, the vehicle 10 may include multiple controllers for controlling various subsystems of the vehicle 10. The vehicle 10 may include a battery electric vehicle (BEV), whereby the at least one torque machine 40 includes an electric machine/motor. For instance, the at least one electric machine 40 may include a first torque machine (TM1) 40a (e.g., first electric machine) capable of providing torque to a rear left wheel 50a and a second torque machine (TM2) 40b (e.g., second electric machine) capable of providing torque to a rear right wheel 50b independently of the torque provided by the TM1 40a to the rear left wheel 50a. Here, the TM1, TM2 may each include a corresponding electric machine that provides the torque to a respective drive shaft coupled for common rotation with the respective wheel 50a, 50b. Alternatively, the TM1, TM2 may each correspond to in-wheel motors associated with respective ones of the rear left and right wheels 50a, 50b. In some examples, a single torque machine 40 is capable of providing torque to each of the rear wheels 50a, 50b independently.

In some configurations, the BEV 10 is rear-wheel drive (RWD) such that only the rear wheels 50a, 50b are powered by torque provided from the at least one electric machine 40, whereby the front left wheel 50c and the front right wheel 50d are not powered by any power source and are configured to rotate freely. Notably, the front wheels 50c, 50d may include steerable wheels that steer the vehicle left when a steering wheel input 20a indicates the steering wheel is rotated counterclockwise and likewise steer the vehicle right when the steering wheel input 20b indicates the steering wheel is rotated clockwise.

In other configurations, the BEV 10 is a four-wheel drive (4WD) or all-wheel drive (AWD) vehicle such that the front wheels are also powered by torque provided from the at least one electric machine 40. Here, the at least one electric machine 40 may include a third torque machine (TM3) 40c (e.g., third electric machine) capable of providing torque to a front left wheel 50c and a fourth torque machine (TM4) 40d) (e.g., fourth electric machine) capable of providing torque to a rear left wheel 50d independently of the torque provided by TM3 to the rear right wheel 50c. In these configurations, each corresponding TM1, TM2, TM3, TM4 is configured to provide torque to the respective wheel 50a, 50b, 50c, 50d independently of the torque provided to the other wheels. Like the first and second electric machines TM1 40a, TM2 40b, the third and fourth electric machines TM3 40c, TM4 40d may provide the torque to a respective drive shaft coupled for common rotation with the respective wheel 50c, 50d or the third and fourth electric machines TM3 40c, TM4 40d may include in-wheel motors associated with respective ones of the front left and right wheels 50c, 50d. The vehicle 10 may also include a plug-in hybrid electric vehicle (HEV) or internal combustion engine (ICE) vehicle. In the case of HEV, at least one torque machine 40 may include an electric machine/motor while at least one other torque machine 40 may include an internal combustion engine. In the case of the ICE vehicle, the at least one torque machine 40 includes an internal combustion engine.

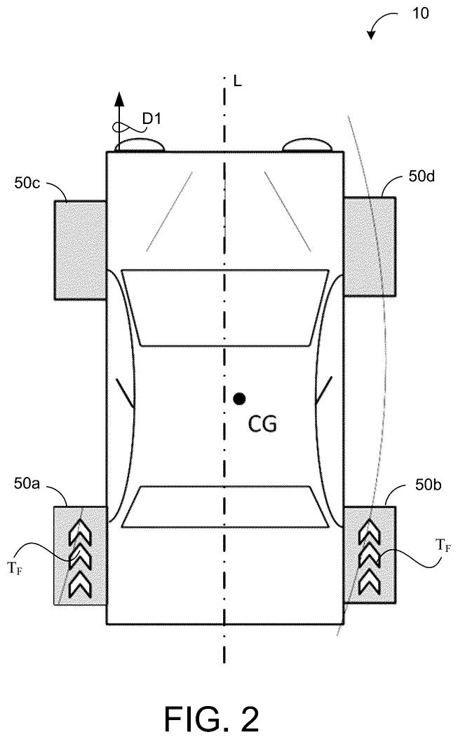

The controller 100 includes data processing hardware 102 and memory hardware 104 in communication with the data processing hardware and storing instructions that when executed on the data processing hardware 102 causes the data processing hardware 102 to perform operations. Specifically, the operations may include operating the vehicle 10 in a normal mode and a drift and power slide mode. As used herein, the drift and power slide mode may be referred to as a drift mode for simplicity but is understood to be capable of performing both drift maneuvers and/or power slide maneuvers. The controller 100 may command the at least one electric machine 40 to provide torque to at least the rear wheels 50a, 50b when the vehicle 10 operates in the normal driving mode. For instance, FIG. 2 shows the vehicle 10 operating in the normal driving mode with the at least one electric machine 40 providing forward torques T_{F} to the rear left wheel 50a and the rear right wheel 50b. In some examples, the first TM1 40a provides forward torque T_{F} to the rear left wheel 50a and the second TM2 40b provides forward torque T_{F} to the rear right wheel 50b. Here, the forward torques T_{F} provided to the rear left wheel 50a and the rear right wheel 50b propel the vehicle 10 along a surface (e.g., ground/roadway) in a first direction D1 of travel substantially parallel to a longitudinal axis L of the vehicle 10. While a RWD vehicle 10 is depicted, a 4WD/AWD vehicle 10 would include the controller 100 also providing forward torques to each of the front left wheel 50c and the front right wheel 50d.

Referring back to FIG. 1, the controller 100 is in communication with a plurality of passenger inputs 20 associated with operating the vehicle 10. The passenger inputs 20 may include, without limitation, a steering input 20a, a torque request input 20b, a user interface (UI) input 20c, and a driving mode input 20d. The steering input 20a may include an input for turning the steerable front wheels 50c, 50d of the vehicle in one of a left direction DL or a right direction DR. For instance, the steering input 102 may correspond to a rotatable position of a steering wheel of the vehicle, whereby a driving passenger may rotate the steering wheel counterclockwise to turn the steerable wheels 50c, 50d in the left direction DL and rotate the steering wheel clockwise to turn the steerable wheels 50c, 50d in the right direction DR. The steering input 20a may include a turning angle indication indicating the turn of front wheels 50c, 50d in the left direction DL or the right direction DR by a turning angle α relative to the first direction D1 of travel of the vehicle 10. For instance, a magnitude of the turning angle α may increase proportional to how much the steering wheel is rotated. A rotational sensor disposed in a steering column of the steering wheel may indicate the turning angle of the wheels 50c, 50d.

The torque request input 20b may correspond to torque requested by the driver for propelling the vehicle. For instance, the torque request input 20b may correspond to an accelerator pedal input or throttle input from the driving passenger that may cause the vehicle to accelerate, decelerate, or maintain a current velocity depending on a position of the accelerator pedal or throttle. The torque request input 20b may optionally correspond to torque requested by an adaptive cruise control (ACC) system to cause the vehicle to accelerate, decelerate, or maintain a current velocity of the vehicle.

The UI input 20c may indicate selection of a graphical element presented in a graphical user interface displayed on a screen in the interior of the vehicle 10 or displayed on a screen of a mobile computing device associated with the passenger. For instance, the passenger may select a graphical element to issue a drift mode enable request to enable operation of the vehicle in the drift mode such the controller 100 receives a resulting UI input 20c conveying the drift mode enable request. Similarly, the UI input 20c may correspond to a voice command spoken by the passenger to enable operation of the vehicle 10 in the drift mode. Optionally, the UI input 20C may correspond to a predefined gesture performed by the passenger to enable operation of the vehicle 10 in the drift mode.

The driving mode input 20d may include input of the drift mode enable request from the passenger of the vehicle to enable operation of the vehicle in the drift mode. Thus, the driving mode input 20d may include UI inputs 20c as discussed above. Additionally or alternatively, the driving mode input 20d may indicate the issuance of the drift mode enable request by the passenger when a physical button disposed in an interior of the vehicle 10 is touched/pressed. For instance, a physical button may be disposed a center console of the vehicle proximate to buttons/switches for controlling various components/systems of the vehicle such as temperature, windows, and infotainment. The button for issuing the drift mode enable request could be disposed on the steering wheel in some configurations. In some examples, the driving mode input 20d indicate the issuance of the drift mode enable request by the passenger when a lever or switch disposed in the interior of the vehicle is actuated. For example, a paddle/lever may be disposed behind the steering wheel so that the passenger can actuate the paddle/lever to issue the drift mode enable request without removing his/her hands from the steering wheel. The passenger may optionally provide the driving mode input 20d via performing a predefined gesture or gazing at particular location to trigger the drift mode enable request.

With continued reference to FIG. 1, the controller 100 is in communication with the plurality of vehicle sensors 30 that each provide data indicative of operation of the vehicle 10. The controller 30 uses the data received from the vehicle sensors 30 to control how torque is provided to the wheels for initiating and holding both drift and power slide maneuvers through completion with minimal driver input. Wheel rotation sensors 30a that indicate rotational velocity of each of the wheels 50. The controller 100 may determine whether or not any of the wheels 50 are slipping at any given instance based on the respective rotational velocity of each wheel measured by a respective wheel rotation sensor 30a.

Orientation sensors 30b (e.g., a gyroscope, compass, global positioning system (GPS), etc.) may provide data indicative of the orientation of the vehicle in three-dimensional space any point in time. For instance, the orientation sensors 116 may provide data to the controller indicating a pitch angle, yaw angle, and/or roll angle of the vehicle during operation of the vehicle in the normal driving mode and during operation of the vehicle in the drift mode.

An acceleration sensor 30c may provide data indicative of acceleration of the vehicle. The acceleration sensor 30c may include an accelerometer. The acceleration sensor 30c may provide lateral acceleration the vehicle is experiencing during various stages while operating in the drift mode. Vehicle speed sensor 30d may provide a velocity/speed of the vehicle 10.

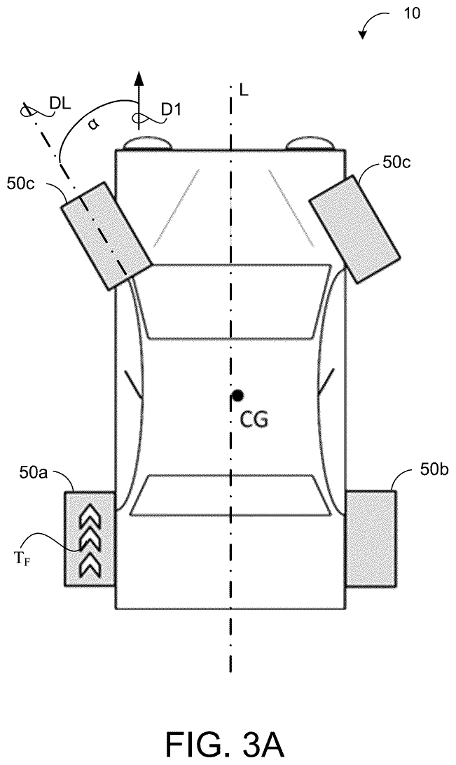

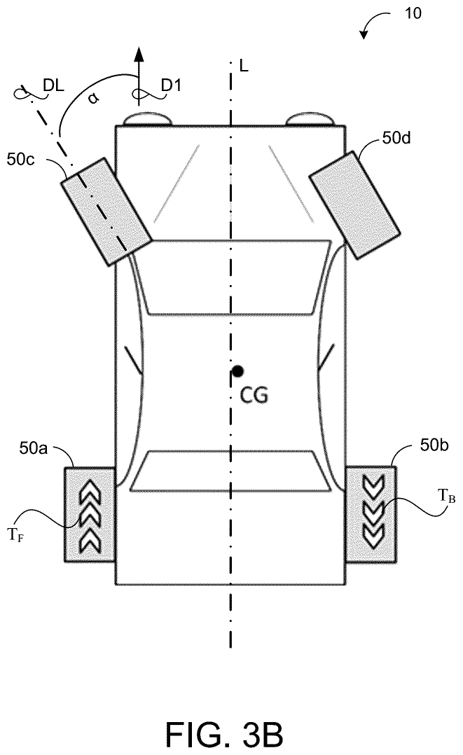

With reference to FIGS. 1-3B, while operating in the normal drive mode (FIG. 2), the controller 100 receives a steering input 20a corresponding to a turning angle indication that indicates a turn of the front wheels 50c, 50d of the vehicle 10 in one of the left direction DL or the right direction DR by a turning angle α relative to the first direction D1 of travel of the vehicle 10. Thereafter, the controller 10 determines that a magnitude of the turning angle α satisfies a threshold turn angle. Based on determining that the magnitude of the turning angle α satisfies the threshold turn angle, FIGS. 3A and 3B shows the controller 100 transitioning from operating the vehicle in the normal drive mode to operating the vehicle in the drift mode. In some examples, a value of the threshold turn angle changes dynamically based on the velocity/speed (i.e., received from speed sensor 30d) of the vehicle 10 when the steering input 20a is received. For instance, the value of the threshold turn angle threshold may decrease as the velocity/speed f the vehicle increases. In some examples, the value of the threshold turn angle is determined based on a function of at least one of velocity of the vehicle, surface conditions, tire rating, or temperature. For instance, at a given velocity of the vehicle may be too slow to perform the drift maneuver on dry pavement but suitable for performing the drift maneuver on a gravel surface or snow-covered/wet pavement. In this scenario, the threshold turn angle may be set to an infinite high value when the vehicle is on dry pavement and traveling at the velocity to slow to perform the turning maneuver so that any turn angle is incapable of satisfying the threshold turn angle. Similarly, the value of the threshold turn angle may be set to a higher value when the ambient temperature is warmer since friction between tires and the surface may be higher than when the ambient temperature is cooler.

In some implementations, the controller 100 optimally determines that the steering input 20a indicates rotation of the steering wheel in one of the counterclockwise direction or the clockwise direction by a threshold amount within a threshold period of time. In these implementations, operating the vehicle in the drift mode is further based on determining that the steering input 20a indicates rotation of the steering wheel in the one of the counterclockwise direction or the clockwise direction by the threshold amount within the threshold period of time.

In some configurations, operation of the vehicle in the drift mode must also be enabled by a passenger of the vehicle at the time the controller 100 determines the magnitude of the turn angle α satisfies the turn angle threshold before the controller 100 will transition the vehicle 10 from operating in the normal driving mode to the drift mode. As described in greater detail above in the preceding paragraphs, the controller may receive a drift mode enable request, i.e., via a UI input 20c and/or drive mode input 20d) from the passenger of the vehicle 10 to enable operation of the vehicle in the drift mode.

The controller 100 operates the vehicle 10 in the drift mode by first determining that an inner rear wheel includes one of the left rear wheel 50a or the right rear wheel 50b and determining that an outer rear wheel includes the other one of the left rear wheel 50a or the right rear wheel 50b. Specifically, the controller determines that the inner rear wheel includes the left rear wheel 50a and the outer rear wheel includes the right rear wheel 50b during operation of the drift mode when the turning angle indication indicates the turn of the front wheels 50c, 50d in the left direction DL. FIGS. 3A and 3B each show the vehicle operating in the drift mode whereby the turning angle indication indicates the turn of the front wheels 50c, 50d in the left direction DL by the turning angle α relative to the first direction D1 of travel. While not shown, in scenarios when the turning angle indication indicates the front wheels turning in the right direction DR, the controller 100 would instead determine that the inner rear wheel includes the right rear wheel 40b and the outer rear wheel includes the left rear wheel 50b.

After determining the inner rear wheel and the outer rear wheel, the controller 100 operates the vehicle in the drift mode by commanding the at least one torque machine 40 to provide forward torque T_{F} to the inner rear wheel 50 without providing any forward torque to the outer rear wheel of the vehicle 10. In the example of FIG. 3A, the controller 100 commands the at least one torque machine 40 (e.g., TM1 40a) to provide the forward torque T_{F} to the left rear wheel 50a and commands the at least one electric machine 40 (e.g., TM2 40b) to no not provide any torque (i.e., no forward/backward torque) to the right rear wheel 50b. On the other hand, the example of FIG. 3B shows the controller 100 commanding the at least one torque machine 40 (e.g., TM1 40a) to provide the forward torque T_{F} to the left rear wheel 50a and commands the at least one electric machine 40 (e.g., TM2 40b) to provide backward torque TB to the right rear wheel 50b.

The controller 100 may determine whether or not to command the at least one electric machine to provide backward torque TB or no torque to the outer rear wheel (e.g., right rear wheel 50b in the example of FIGS. 3A and 3B) based on operating parameters of the vehicle before and while initiating different stages (e.g., drift maneuver and power slide maneuver) of the drift mode as well as to hold the drift maneuver and/or power slide maneuver through completion. That is, the controller 100 may command the at least one torque machine 40 to provide backward torque or not provide any torque to the rear outer wheel depending one or more of acceleration of the vehicle, orientation of the vehicle, slippage of the wheels, steering input, and velocity/speed of the vehicle. In some examples, the controller 100 commands the at least one torque machine 40 to modulate application of the backward torque TB provided to the outer rear wheel. Additionally or alternatively, the controller 100 may instruct the at least one torque machine 40 to modulate the forward torque T_{F} provided to the rear inner wheel.

While not depicted in the examples of FIGS. 3A and 3B, during operation of the vehicle in the drift mode when the vehicle 10 is configured for 4WD/AWD, the controller 100 may further determine that an inner front wheel includes one of the left front wheel 50c or the right front wheel 50d and an outer front wheel includes the other one of the left front wheel 50c or the right front wheel 50d. Specifically, the controller may determine that the inner front wheel includes the left front wheel 50c and the outer front wheel includes the right front wheel 50d when the turning angle indication indicates the turn of the front wheels 50c, 50d in the left direction DL. However, when the turning angle indication indicates the turn of the front wheels 50c, 50d in in the right direction DR, the controller would determine that the inner front wheel includes the right front wheel 50d and the outer front wheel includes the left front wheel 50c. Thereafter, the controller 100 commands the at least one torque machine to provide forward torque T_{F} to the inner front wheel without providing any forward torque to the outer front wheel of the vehicle.

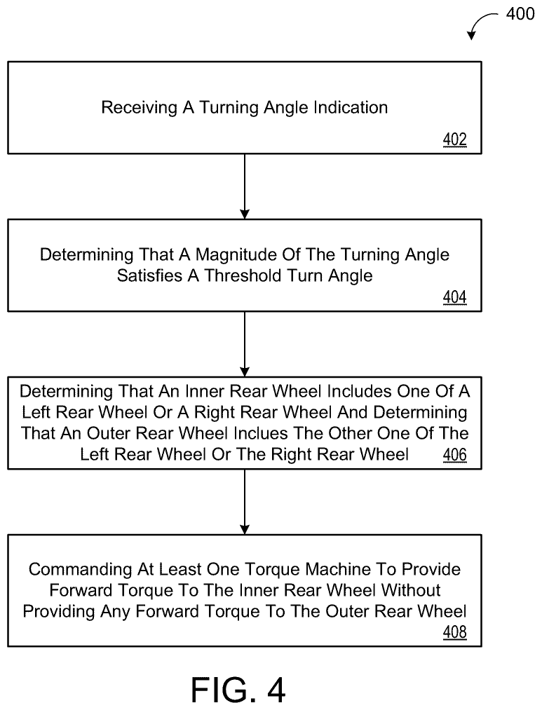

FIG. 4 is a flowchart of an example arrangement of operations for a method 400 of operating a vehicle in a drift mode. The method 400 may execute on the data processing hardware 102 of the vehicle 10 based on instructions stored on the memory hardware 104 of the vehicle. Operations 402 and 404 are performed during operation of the vehicle in a normal driving mode, whereby at least one torque machine 40 is providing forward torque T_{F} to each of a left rear wheel 50a and a right rear wheel 50b to propel the vehicle along a surface in a first direction D1 substantially parallel to a longitudinal axis L of the vehicle 10.

At operation 402, the method 400 includes receiving a turning angle indication 30a indicating a turn of front wheels 50c, 50d of the vehicle 10 in one of a left direction DL or a right direction DR by a turning angle α relative to the first direction D1 of travel of the vehicle 10. At operation 404, the method 400 includes determining that a magnitude of the turning angle α satisfies a turn angle threshold.

Based on determining that the magnitude of the turning angle satisfies the threshold turn angle, the method includes operating the vehicle in the drift mode by determining that an inner rear wheel includes one of the left rear wheel 50a or the right rear wheel 50b and determining that an outer rear wheel includes the other one of the left rear wheel 50a or the right rear wheel 50b at operation 406, and commanding at least one torque machine 40 to provide forward torque T_{F} to the inner rear wheel without providing any forward torque to the outer rear wheel of the vehicle 10 at operation 408. In some examples, the torque machine 40 is commanded to not provide any torque to the outer rear wheel to permit the outer rear wheel to rotate freely, as shown in FIG. 3A. In other examples, the at least one torque machine 40 is commanded to provide backward torque TB to the outer rear wheel of the vehicle, as shown in FIG. 3B.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

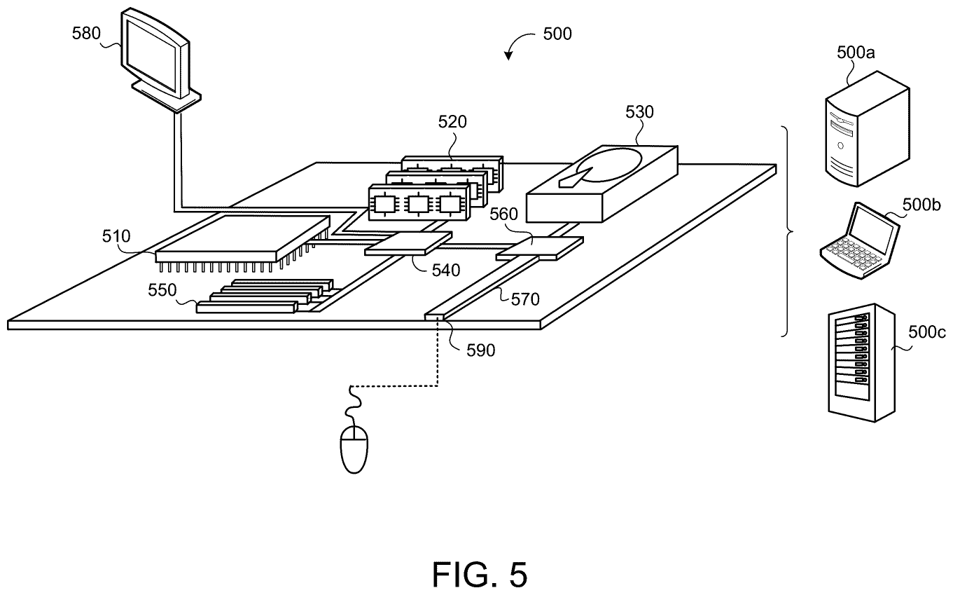

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor (e.g., data processing hardware 102 of FIG. 1) 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory (e.g., memory hardware 104 of FIG. 1) 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware of a vehicle that causes the data processing hardware to perform operations comprising:
during operation of the vehicle in a normal driving mode:
receiving a turning angle indication indicating a turn of front wheels of the vehicle in one of a left direction or a right direction by a turning angle relative to a first direction of travel of the vehicle; and
determining that a magnitude of the turning angle satisfies a threshold turn angle; and
based on determining that the magnitude of the turning angle satisfies the threshold turn angle, operating the vehicle in a drift mode by:
determining that an inner rear wheel comprises one of a left rear wheel or a right rear wheel of the vehicle;
determining that an outer rear wheel comprises the other one of the left rear wheel or the right rear wheel; and
commanding at least one torque machine to provide forward torque to the inner rear wheel without providing any forward torque to the outer rear wheel of the vehicle.

2. The computer-implemented method of claim 1, wherein, during operation of the vehicle in the normal driving mode, the at least one torque machine is providing forward torque to each of the right rear wheel and the left rear wheel of the vehicle to propel the vehicle along a surface in the first direction of travel substantially parallel to a longitudinal axis of the vehicle.

3. The computer-implemented method of claim 1, wherein determining that the inner rear wheel comprises one of the left rear wheel or the right rear wheel comprises:
determining that the inner rear wheel comprises the left rear wheel when the turning angle indication indicates the turn of the front wheels in the left direction; or
determining that the inner rear wheel comprises the right rear wheel when the turning angle indication indicates the turn of the front wheels in the right direction.

4. The computer-implemented method of claim 1, wherein, during operation of the vehicle in the drift mode, commanding the at least one torque machine to provide forward toque to the inner rear wheel without providing any forward torque to the outer rear wheel of the vehicle comprises commanding the at least one torque machine to not provide any torque to the outer rear wheel to permit the outer rear wheel to rotate freely.

5. The computer-implemented method of claim 1, wherein, during operation of the vehicle in the drift mode, commanding the at least one torque machine to provide forward torque to the inner rear wheel without providing any forward torque to the outer rear wheel of the vehicle comprises commanding the at least one torque machine to provide a backward torque to the outer rear wheel of the vehicle.

6. The computer-implemented method of claim 1, wherein the operations further comprise:
receiving a drift mode enable request from a passenger of the vehicle to enable operation of the vehicle in the drift mode; and
transitioning the vehicle from operating in the normal driving mode to the drift mode in response to determining that both operation of the vehicle in the drift mode is enabled and the magnitude of the turning angle satisfies the threshold turn angle.

7. The computer-implemented method of claim 6, wherein the passenger issues the drift mode enable request via at least one of:
pressing a physical button disposed in an interior of the vehicle;
actuating a lever or switch disposed in an interior of the vehicle;
selecting a graphical element presented in a graphical user interface displayed on a screen in the interior of the vehicle;
selecting a graphical element presented in a graphical user interface displayed on a screen of a mobile computing device associated with the passenger; or
receiving a voice command spoken by the passenger that requests to enable the operation of the vehicle in the drift mode.

8. The computer-implemented method of claim 1, wherein operating the vehicle in the drift mode further comprises:
determining that an inner front wheel comprises one of a left front wheel or a right front wheel;
determining that an outer front wheel comprises the other one of the left front wheel or the right front wheel; and
commanding the at least one torque machine to provide forward torque to the inner front wheel without providing any forward torque to the outer front wheel of the vehicle.

9. The computer-implemented method of claim 1, wherein the at least one torque machine comprises:
a first electric motor connected to the right rear wheel and configured to provide forward torque or backward torque to the right rear wheel; and
a second electric motor connected to the left rear wheel and configured to provide forward torque or backward torque to the left rear wheel.

10. The computer-implemented method of claim 1, wherein the operations further comprise:
receiving a velocity of the vehicle when the turning angle indication indicating the turn of front wheels of the vehicle in one of the left direction or the right direction is received,
wherein operating the vehicle in the drift mode further comprises determining a value of the turn angle threshold based on the velocity of the vehicle.

11. The computer-implemented method of claim 1, wherein receiving the turning angle indication comprises receiving a steering wheel input indicating rotation of the steering wheel in one of a counterclockwise direction to cause the front wheels to turn in the left direction or the clockwise direction to cause the front wheels to turn in the right direction.

12. The computer-implemented method of claim 11, wherein the magnitude of the turning angle is proportional to an amount the steering wheel rotates in the one of the counterclockwise direction or the clockwise direction.

13. The computer-implemented method of claim 11, wherein the operations further comprise:
determining that the steering wheel input indicates rotation of the steering wheel in the one of the counterclockwise direction or the clockwise direction by a threshold amount within a threshold period of time,
wherein operating the vehicle in the drift mode is further based on determining that the steering wheel input indicates the rotation of the steering wheel in the one of the counterclockwise direction or the clockwise direction by the threshold amount within the threshold period of time.

14. A vehicle comprising:
a pair of front wheels;
a pair of rear wheels;
at least one torque machine; and
a controller in communication with the at least one torque machine and configured to perform operations comprising
during operation of the vehicle in a normal driving mode:
receiving a turning angle indication indicating a turn of the front wheels of the vehicle in one of a left direction or a right direction by a turning angle relative to a first direction of travel of the vehicle; and
determining that a magnitude of the turning angle satisfies a threshold turn angle; and
based on determining that the magnitude of the turning angle satisfies the threshold turn angle, operating the vehicle in a drift mode by:
determining that an inner rear wheel comprises one of the left rear wheel or the right rear wheel;
determining that an outer rear wheel comprises the other one of the left rear wheel or the right rear wheel; and
commanding the at least one torque machine to provide forward torque to the inner rear wheel without providing any forward torque to the outer rear wheel of the vehicle.

15. The vehicle of claim 14, wherein, during operation of the vehicle in the normal driving mode, the at least one torque machine is providing forward torque to each of the right rear wheel and the left rear wheel of the vehicle to propel the vehicle along a surface in the first direction of travel substantially parallel to a longitudinal axis of the vehicle.

16. The vehicle of claim 14, wherein determining that the inner rear wheel comprises one of the left rear wheel or the right rear wheel comprises:
determining that the inner rear wheel comprises the left rear wheel when the turning angle indication indicates the turn of the front wheels in the left direction; or
determining that the inner rear wheel comprises the right rear wheel when the turning angle indication indicates the turn of the front wheels in the right direction.

17. The vehicle of claim 14, wherein, during operation of the vehicle in the drift mode, commanding the at least one torque machine to provide forward toque to the inner rear wheel without providing any forward torque to the outer rear wheel of the vehicle comprises commanding the at least one torque machine to not provide any torque to the outer rear wheel to permit the outer rear wheel to rotate freely.

18. The vehicle of claim 14, wherein, during operation of the vehicle in the first mode, commanding the at least one torque machine to provide forward torque to the inner rear wheel without providing any forward torque to the outer rear wheel of the vehicle comprises commanding the at least one torque machine to provide a backward torque to the outer rear wheel of the vehicle.

19. The vehicle of claim 14, wherein the operations further comprise:
receiving a drift mode enable request from a passenger of the vehicle to enable operation of the vehicle in the drift mode,
transitioning the vehicle from operating in the normal driving mode to the drift mode in response to determining that both operation of the vehicle in the drift mode is enabled and the magnitude of the turning angle satisfies the threshold turn angle.

20. The vehicle of claim 19, wherein the passenger issues the drift mode enable request via at least one of:
pressing a physical button disposed in an interior of the vehicle;
actuating a lever or switch disposed in an interior of the vehicle;
selecting a graphical element presented in a graphical user interface displayed on a screen in the interior of the vehicle;
selecting a graphical element presented in a graphical user interface displayed on a screen of a mobile computing device associated with the passenger; or
receiving a voice command spoken by the passenger that requests to enable the operation of the vehicle in the drift mode.

21. The vehicle of claim 14, wherein operating the vehicle in the drift mode further comprises:
determining that an inner front wheel comprises one of a left front wheel or a right front wheel;
determining that an outer front wheel comprises the other one of the left front wheel or the right front wheel; and
commanding the at least one torque machine to provide forward torque to the inner front wheel without providing any forward torque to the outer front wheel of the vehicle.

22. The vehicle of claim 14, wherein the at least one torque machine comprises:
a first electric motor connected to the right rear wheel and configured to provide forward torque or backward torque to the right rear wheel; and
a second electric motor connected to the left rear wheel and configured to provide forward torque or backward torque to the left rear wheel.

23. The vehicle of claim 14, wherein the operations further comprise:
receiving a velocity of the vehicle when the turning angle indication indicating the turn of front wheels of the vehicle in one of the left direction or the right direction is received,
wherein operating the vehicle in the drift mode further comprises determining a value of the turn angle threshold based on the velocity of the vehicle.

24. The vehicle of claim 14, wherein receiving the turning angle indication comprises receiving a steering wheel input indicating rotation of the steering wheel in one of a counterclockwise direction to cause the front wheels to turn in the left direction or the clockwise direction to cause the front wheels to turn in the right direction.

25. The vehicle of claim 24, wherein the magnitude of the turning angle is proportional to an amount the steering wheel rotates in the one of the counterclockwise direction or the clockwise direction.

26. The vehicle of claim 24, wherein the operations further comprise:
determining that the steering wheel input indicates rotation of the steering wheel in the one of the counterclockwise direction or the clockwise direction by a threshold amount within a threshold period of time,
wherein operating the vehicle in the drift mode is further based on determining that the steering wheel input indicates the rotation of the steering wheel in the one of the counterclockwise direction or the clockwise direction by the threshold amount within the threshold period of time.
